(19) United States
(12) Patent Application Publication
(10) Pub. No.: US 2026/0158334 A1
(43) Pub. Date: Jun. 11, 2026

(54) Systems and Methods for a Light-up Object with Enhanced Features

(71) Applicant: Nite Ize, Inc., Boulder, CO (US)

(72) Inventor: Bowden ORMSBEE, Longmont, CO (US)

(73) Assignee: Nite Ize, Inc., Boulder, CO (US)

(21) Appl. No.: 19/405,885

(22) Filed: Dec. 2, 2025

Related U.S. Application Data
(60) Provisional application No. 63/730,046, filed on Dec. 10, 2024.

(51) Int. Cl. A63B 37/02; F21S 9/02; F21V 33/00

(52) U.S. Cl. CPC A63B 37/02; F21S 9/02; F21V 33/008; A63B 2225/74

(57) ABSTRACT

A light-up object includes a rubberized outer body; a plug in a cavity of the outer body; and a lighting device located in the plug. The light-up object further includes a first inner capsule piece, the first inner capsule piece located in the plug, and a second inner capsule piece located in the cavity of the outer body, the second inner capsule piece shaped to engage with the first inner capsule piece. The first and second inner capsules are threaded to fit together. The outer body includes grooves, running around multiple circumferences of the outer body. The outer body has a size of approximately a baseball; the outer body is shaped approximately like a sphere; and the grooves are at least 5 mm deep in the outer body.

This application claims the benefit of U.S. Provisional Patent Application Ser. No. 63/730,046, filed Dec. 10, 2024, the entire disclosure of which are incorporated by reference herein.

### BACKGROUND OF THE INVENTION

Ball shaped lighted objects are sometimes used as toys. One of ordinary skill in the art will appreciate that it is desirable for such devices withstand typical wear and tear, especially when the toy is a dog toy designed for low light play.

One known product is the device described in U.S. Pat. No. 10,512,247, which is incorporated by reference herein, which is directed to a molded rubber shell with external ridges. More specifically, as shown in FIG. 1, the ball 100 possesses a plurality of grooves 110 that improves grip for a hand, a launcher, or a dog's mouth. The grooves 110 also cause irregular bounce behavior, which keeps the dog engaged. In some instances, the grooves 110 terminate in depressions 115. A central depression 120 extends into an outer body 125 of the ball 100. The ball 100 is configured to accommodate a lighting module that can be selectively illuminated or activated by motion and/or shock. In one embodiment, a light associated with the lighting module turns on when the ball moves or impacts a surface.

The lighting module of existing devices relies on replaceable batteries. Even though the batteries can power the lighting module for extended periods of time, users often desire rechargeable options because the small batteries commonly used are expensive and sometimes difficult to replace, especially for the dexterity challenged. Existing devices depend on disposable coin cell batteries, wherein users must replace depleted batteries. The finite run time restricts long term use. The presence of a battery compartment and replaceable batteries also introduce sealing limits that can affect durability in heavy use or extended water exposure. The automatic shutoff limits session length and requires repeated reactivation.

There is a need for a lighted ball that uses a rechargeable power source. A rechargeable design can reduce maintenance, improve durability, and extend operating life. A sealed rechargeable system can also improve water resistance and impact resistance.

### SUMMARY OF THE INVENTION

It is one aspect of some embodiments of the present invention to provide a lighted play object for animals comprised of a shell that is at least partially translucent. The shell, i.e., outer surface of the ball, impact resilient and possesses grooves and depressions that can maintain partial airflow if the object becomes lodged in a mouth or throat. These structures may act as light windows and grip surfaces while preserving durability in other regions.

The shell is configured to selectively receive a removable plug assembly that holds a lighting module. The plug one embodiment of the present invention consists of an overmolded elastomer section and a rigid threaded section that mates with complementary threads in the cavity. The plug also may have a screwdriver notch that allows torque application for installation and removal.

It is another aspect of embodiments of the present invention to provide a lighting module that includes a rechargeable battery, at least one LED, and control electronics on a primary board. Some embodiments include a secondary board that holds the battery and a charge port. LEDs may be placed on one or both sides of the module.

It is contemplated that control electronics may use a system comprised of one or more accelerometers to manage light activation. One embodiment, when the system detects an impulse above a set threshold, the LEDs enter a first active state for a defined period. A timer associated with the control electronics may reset upon subsequent impulses. If no qualifying impulse occurs, the device may enter a second flashing state, then transition to a low power sleep mode until subsequent movement is detected. In one embodiment of the present invention, low battery charge condition is indicated by a fast-blinking mode.

In operation, the plug and associated threaded container work with the shell to provide IPX8 water resistance and buoyancy. The shell may take various shapes, including spherical, elongated, angular, or novelty forms, while retaining groove and depression features for airflow, light transmission, and grip. It is a related aspect of some embodiments of the present invention to provide a plug system for lighted animal play objects. The plug houses a rechargeable battery, at least one lighting element, and control electronics. The contemplated plug allows users to upgrade prior products without changing ball structure. This new plug system, thus, increases service life, reduces maintenance, and expands lighting capability of existing light up ball products.

The Summary of the Invention is neither intended nor should it be construed as being representative of the full extent and scope of the present invention. That is, these and other aspects and advantages will be apparent from the disclosure of the invention(s) described herein. Further, the above-described embodiments, aspects, objectives, and configurations are neither complete nor exhaustive. As will be appreciated, other embodiments of the invention are possible using, alone or in combination, one or more of the features set forth above or described below. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present invention are possible utilizing, alone or in combination, as set forth above and/or described in the accompanying figures and/or in the description herein below.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and drawing figures are to be understood as being approximations which may be modified in all instances as required for a particular application of the novel assembly and method described herein.

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C., Section 112(f). Accordingly, a claim incorporating the term “means” shall cover all structures, materials, or acts set forth herein, and all of the equivalents thereof. Further, the structures, materials, or acts and the equivalents thereof shall include all those described in the Summary, Brief Description of the Drawings, Detailed Description and in the appended drawing figures.

### BRIEF DESCRIPTION OF THE DRAWINGS

The accompanying drawings, which are incorporated in and constitute a part of the specification, illustrate embodiments of the invention and together with the general description of the invention given above and the detailed description of the drawings given below, serve to explain the principles of these inventions.

FIG. 1 is a perspective view of one embodiment of a light-up object.

FIG. 2 shows another perspective view of the light-up object of FIG. 1.

FIG. 3 is a side elevation view of the light-up object of FIG. 1.

FIG. 4 is an exploded view of the light-up object of FIG. 1.

FIG. 5 is a cross-section of a plug portion of the light-up object shown in FIG. 1.

FIG. 6 is an exploded view of the plug portion.

FIG. 7 is a front perspective view showing primary and secondary control boards with an interconnected rechargeable battery.

FIG. 8 is a rear perspective view showing the primary and secondary control boards.

FIG. 9 is a cross-section of the body portion of the light-up object of FIG. 1.

FIG. 10 shows an embodiment of the cap portion of the light-up object of FIG. 1.

The following component list and associated numbering found in the drawings is provided to assist in the understanding of one embodiment of the present invention:

| # | Component |
|---|---|
| 100 | Ball |
| 110 | Grooves |
| 115 | Depressions |
| 120 | Depressions |
| 125 | Outer body |
| 210 | Plug |
| 220 | Indentation |
| 230 | Cavity |
| 410 | Overmold section |
| 420 | Screw section |
| 422 | Module cap |
| 430 | Lighting module |
| 440 | Power source |
| 442 | Charge port |
| 450 | Lighting source |
| 460 | Control board |
| 462 | Control board |
| 510 | Screwdriver notch |
| 610 | Threaded container |

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

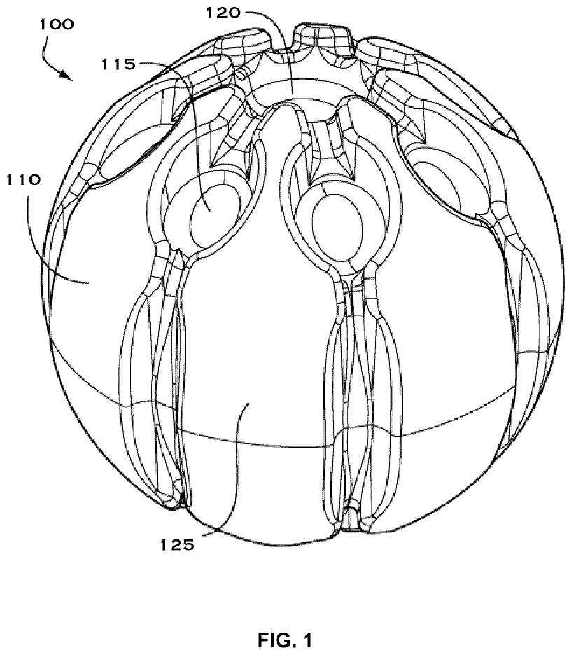

FIGS. 1-3 shows a light-up object, e.g., a ball 100, with enhanced features of one embodiment of the present invention. In the embodiment shown, ball 100 includes a rounded outer shell made out of Thermo Plasticized Rubber (TPR) milky white 40+/−3 shore A. Although an object with a generally spherical profile is shown, other designs are possible, including those with elongated shapes (like footballs), angular shapes (rectangles, squares, or other prism or multi-sided objects), or objects resembling non-ball-like objects such as bones, small animals, etc. One concern users of such a ball 100 may have is that the object will become lodged in the animal's mouth or throat. In such a scenario, the ball 100 is designed to help accommodate an animal's breathing for a brief time until the ball can be removed. This accommodation results from grooves 110 and depressions 115, 120.

Additionally, the grooves 110 and depressions 115, 120 integrated into the body 125 provide additional exterior surface area that allows for enhanced light penetration from a lighting module 430 located inside of the ball 100. Ball 100 of one embodiment is made of a translucent material such as TPR; however, many other translucent materials may be used, especially those that are durable and have a degree of elasticity, enabling the ball 100 to bounce. The grooves 110 and depressions 115, 120 provided do not affect ball durability because the body 125 retains thickness in other areas. Additionally, grooves 110 and depressions 115, 120 enhance ball grip 100, making it easier for the animal to hold the ball in its mouth.

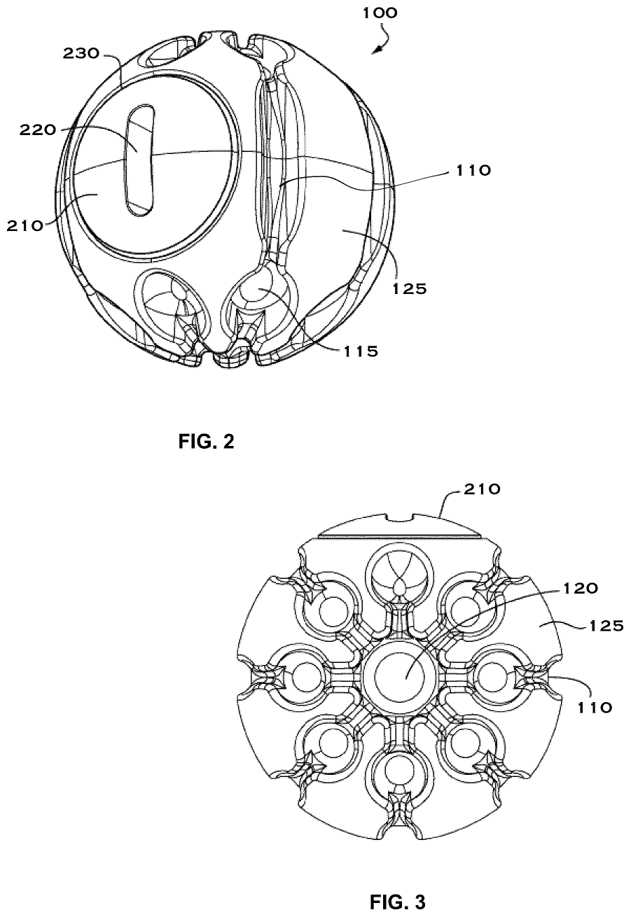

FIG. 2 shows a different perspective view of ball 100 showing a cavity 230 and plug 210, which includes indentation 220. The plug 210 accommodates a lighting module that selectively lights the ball. The indentation 220 assists in providing a means for the removal of plug 210 from cavity 230, because, in one embodiment of the present invention, the plug 210 is fitted into cavity 230 and is held in place via a screw-like interconnection.

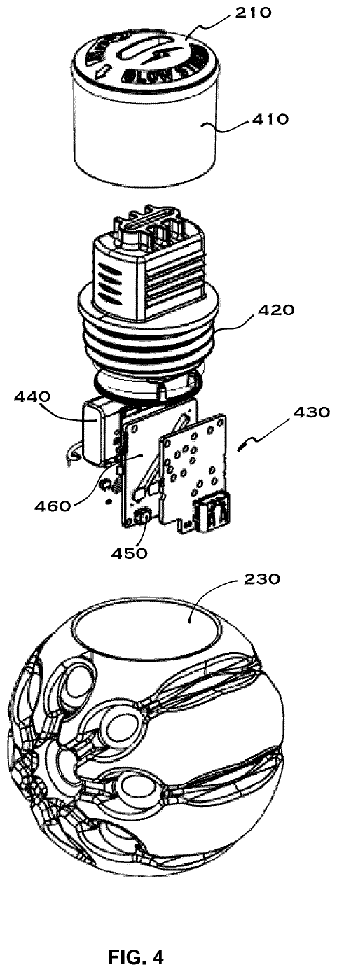

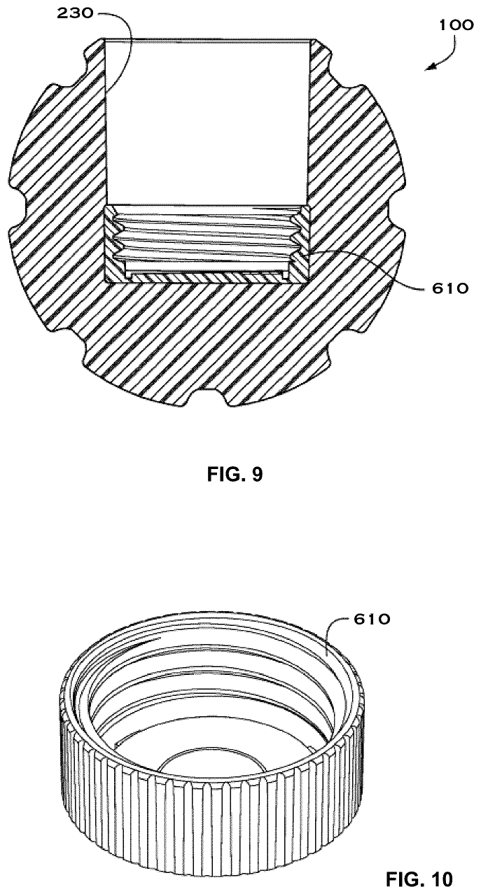

FIG. 4 shows the plug 210 removed from the cavity 230. The plug 210 may consist of an overmolded TPR section 410 and a polycarbonate screw section 420. The cavity 230 includes a reciprocal screw section (see FIG. 9) for selectively receiving screw section 420. In all cases, the material described for these parts is purely exemplary. In many embodiments, the screw sections are made of a more rigid material such as polycarbonate and the ball and plug are made of TPR.

The lighting module 430 is designed to fit into plug 210 and includes a power source 440, such as a rechargeable battery, a lighting source 450, and a control board 460. In many embodiments, the lighting source 450 is an LED. In some embodiments, LEDs are included on both sides of the lighting module 430.

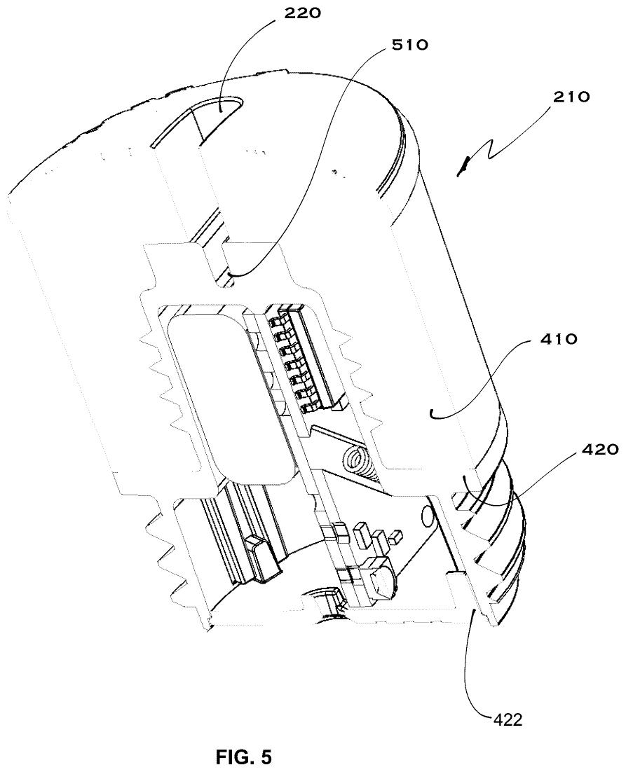

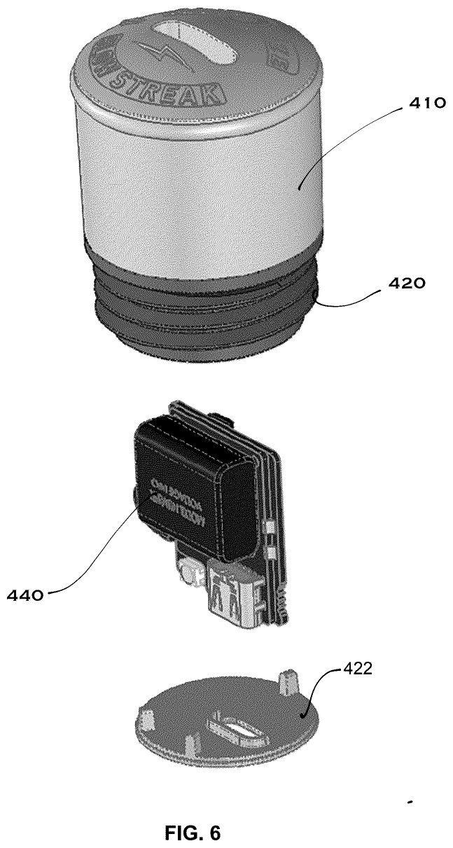

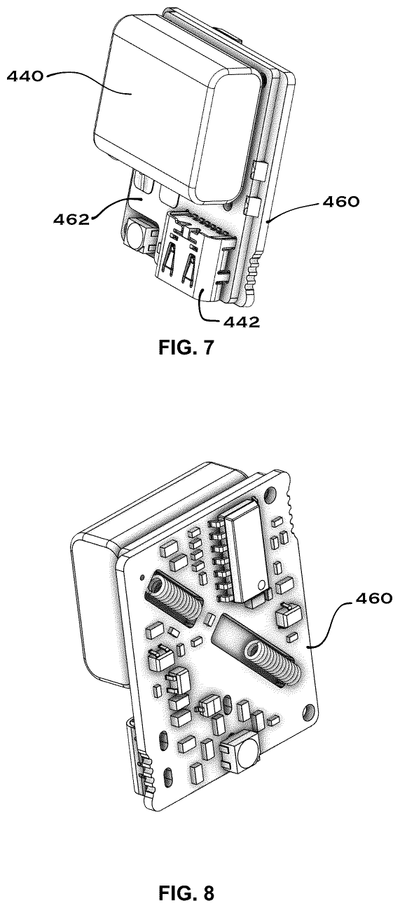

FIGS. 5 and 6 show an overmold section 410 interconnected to a polycarbonate section 420 (also called a first inner capsule). This is typically done to provide a permanent attachment. The polycarbonate screw section 420 includes a screwdriver notch, i.e., the indentation 220, configured to receive a screwdriver tip that is also inserted within a notch 510. A module cap 422 is interconnected to the screw section 420 to effectively seal the plug 210, wherein the only penetration in the module cap accommodates a charge port 442 (see FIG. 7). The internally-disposed threaded container 610 is used by some embodiments of the present invention and is shown in FIGS. 9 and 10. The threaded container is integrated with inner side walls of the cavity, thereby providing an airtight interconnection that will keep water or other materials from affecting the lighting module 430.

The control board 460 controls lighting source 450 activation, typically by detecting acceleration, compression (e.g., generated by a dog bite), or impact event. In one embodiment, the control board 460 includes at least one accelerometer. In many embodiments, the control board 460 includes two accelerometers. The control board 460 and the accelerometers may cooperate to activate and deactivate the lighting source. In one embodiment, when ball 100 experiences sufficient acceleration, the control board 460 activates the lighting source 450. Typically, the acceleration level is set to be somewhat significant, such that simply moving the ball will not cause it to activate. In one embodiment, the control board is set to activate the ball lighting source 450 when an impulse would be experienced by dropping ball 100 against a hard surface from a height of at least about 3 inches. As one of ordinary skill will appreciate, the system may be set to provide activation under various acceleration, pressure, and/or impact scenarios.

In some embodiments, the control board 460 activates the lighting source 450 if the ball is dropped from a height of at least about 1 meter, which eliminates the need for an external switch that may be damaged by an animal bite. A triggering impulse used by some embodiments of the present invention is similar to that encountered when a user slams the ball into one's palm, thereby allowing activation without bouncing.

After activation, the lighting source of one embodiment will stay in a first active mode for a predetermined period of time, e.g., five minutes. In one embodiment, the first active mode will reset if the user creates the requisite impulse onto the ball during the first activation mode. If no significant impulse is experienced during the first activation mode, the control board 460 will transition to a second active mode, wherein the lighting source will blink quickly for a predetermined period of time before deactivating. Any impulse significant to provide a similar impulse as a drop from a height of about 0.6 meters or greater will reactivate the first activation mode.

The principles of another scheme provide for activation of a first lighting state upon receiving an impulse of a first level. The first lighting state continues for a first period of time. If at any time an impulse of a first level is measured, the first period of time resets. If no impulse is received in the first period of time, then a second lighting state is activated. This state continues for a second period of time. At this point, the device enters a sleep mode. This is purely an exemplary method of operation, and in some embodiments, no second lighting state may be activated; instead, the system may initiate a sleep mode wherein the LEDs are deactivated at the end of the first time period. When the sleep mode is active, the unit will remain in a low-power state until significant movement or impulse is detected.

If the battery charge is low, the lighting module of one embodiment of the present invention is configured to emit blinking light. This contemplated low battery signal may be activated when the ball is static or after a significant impulse event.

The foregoing describes examples of a light activation scheme, and others will occur to those of ordinary skill in the art.

FIGS. 7 and 8 show one embodiment of the present invention that employs a primary control board 460 and a secondary control board 462. The secondary control board 462 accommodates the battery and the charge port 442 that selectively accepts an end of a charge cable. One of ordinary skill in the art will appreciate that battery charging can alternatively be accomplished by inductive methods. In many embodiments, parts of the system, especially the control board, are provided in devices including microprocessors. Various embodiments of the systems and methods described herein may be implemented fully or partially in software and/or firmware. Indeed, the control system employed by some embodiments of the present invention are configured to communicate with a software application provided on the user's phone, for example. Such software applications may be further configured to allow the user to configure activation modes, emitted color and/or sound profiles, battery status reminders, etc. One of ordinary skill in the art will appreciate that software/firmware may be selectively updated and/or altered by way of known wireless connection technologies integrated into the ball. Alternatively, the charge cable may be used to facilitate software updates.

The contemplated software and/or firmware may be incorporated into instructions in or on a non-transitory computer-readable storage medium. These instructions then may be read and executed by one or more processors to enable performance of the operations described herein. The instructions may be in any suitable form such as, but not limited to, source code, compiled code, interpreted code, executable code, static code, dynamic code, and the like. Such a computer-readable medium may include any tangible non-transitory medium for storing information in a form readable by one or more computers such as, but not limited to, read only memory (ROM); random access memory (RAM); magnetic disk storage media; optical storage media; a flash memory, etc.

While specific embodiments have been described in detail in the foregoing detailed description and illustrated in the accompanying drawings, it will be appreciated by those skilled in the art that various modifications and alternatives to those details could be developed in light of the overall teachings of the disclosure and the broad inventive concepts thereof. It is understood, therefore, that the scope of this disclosure is not limited to the particular examples and implementations disclosed herein but is intended to cover modifications within the spirit and scope thereof as defined by the appended claims and any and all equivalents thereof.

Exemplary characteristics of embodiments of the present invention have been described. However, to avoid unnecessarily obscuring embodiments of the present invention, the preceding description may omit several known apparatus, methods, systems, structures, and/or devices one of ordinary skill in the art would understand are commonly included with the embodiments of the present invention. Such omissions are not to be construed as a limitation of the scope of the claimed invention. Specific details are set forth to provide an understanding of some embodiments of the present invention. It should, however, be appreciated that embodiments of the present invention may be practiced in a variety of ways beyond the specific detail set forth herein.

Modifications and alterations of the various embodiments of the present invention described herein will occur to those skilled in the art. It is to be expressly understood that such modifications and alterations are within the scope and spirit of the present invention, as set forth in the following claims. Further, it is to be understood that the invention(s) described herein is not limited in its application to the details of construction and the arrangement of components set forth in the preceding description or illustrated in the drawings. That is, the embodiments of the invention described herein are capable of being practiced or of being carried out in various ways. The scope of the various embodiments described herein is indicated by the following claims rather than by the foregoing description. And all changes which come within the meaning and range of equivalency of the claims are to be embraced within their scope. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

The foregoing disclosure is not intended to limit the invention to the form or forms disclosed herein. In the foregoing Detailed Description, for example, various features of the invention are grouped together in one or more embodiments for the purpose of streamlining the disclosure. This method of disclosure is not to be interpreted as reflecting an intention that the claimed inventions require more features than expressly recited. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention. Further, the embodiments of the present invention described herein include components, methods, processes, systems, and/or apparatus substantially as depicted and described herein, including various sub-combinations and subsets thereof. Accordingly, one of skill in the art will appreciate that it would be possible to provide for some features of the embodiments of the present invention without providing others. Stated differently, any one or more of the aspects, features, elements, means, or embodiments as disclosed herein may be combined with any one or more other aspects, features, elements, means, or embodiments as disclosed herein.

What is claimed is:

1. A light-up device comprising:
a rubberized outer body that includes a pair of first depressions on opposing first and second sides of the outer body, a plurality of second depressions on only the first side of the outer body and radially adjacent one of the pair of first depressions, a plurality of third depressions on only the second side of the outer body and radially adjacent the other of the pair of first depressions, and a plurality of grooves defined within an outer surface of the outer body, the plurality of grooves extending between the pair of first depressions, each of the plurality of grooves in open communication with the pair of first depressions, at least one of the plurality of second depressions, and at least one of the plurality of third depressions;
a plug in a cavity of the outer body, the plug accommodating a rechargeable battery and a charge port; and
a lighting device located in the plug.

2. The device of claim 1, wherein the plug houses a charge port accessible when the plug is removed from the cavity.

3. The device of claim 1, wherein the lighting device is a module that comprises a primary control board and a secondary control board, the secondary control board carrying the rechargeable battery and the charge port.

4. The device of claim 1, wherein the outer body comprises an outer shell formed of translucent thermoplastic rubber having a hardness of 40±3 Shore A;
where in the plug includes an overmolded elastomer external section and a rigid polycarbonate threaded section that engages complementary threads in the cavity, the plug further including an external indentation aligned with a tool notch;
a first inner capsule fixed to the plug and a second inner capsule positioned in the cavity, the first and second inner capsules threaded together to define an airtight enclosure; and
a lighting module contained within the airtight enclosure, the module including a rechargeable battery, at least two LEDs, which comprise the lighting device, disposed on opposite sides of a control board, and a motion-activated control module comprising at least two accelerometers.

5. The device of claim 4, wherein the at least two accelerometers are configured to, upon detecting an impulse corresponding to a drop from about 1 meter, place the LEDs in a first active state for about 5 minutes, transition to a flashing state for about 5 minutes if no further qualifying impulse is detected.

6. The device of claim 4, wherein the grooves extend between first depressions located on opposing sides of the outer shell and plural secondary depressions located around each first depression.

7. The device of claim 4, wherein the controller module is configured, upon detecting a low battery condition, to command a fast blinking pattern of the lighting device in response to a qualifying impulse.

8. The device of claim 4, wherein the controller module is further configurable to a second activation setting in which a qualifying impulse corresponds to a drop from about 3 inches to about 2 feet.

9. A light-up device comprising:
an outer body having a cavity that ends in a threaded member;
a plug having a screw section with a treaded outer portion that is configured to selectively interconnect to the threaded member, the screw section having a notch on an upper end thereof configured to receive a tool, the screw section also having an at least partially hollow interior that accommodates a control board that accommodates and/or communicates with an accelerometer;
a rechargeable battery interconnected to the control board;
a charge port electrically coupled to the rechargeable battery and interconnected to the control board;
a lighting device positioned in the hollow interior and electrically coupled to the control board and the rechargeable battery; and
a cap that interfaces with the screw section to substantially seal the hollow interior, wherein the charge port can be accessed through the cap.

10. The device of claim 9, wherein the outer body is shaped approximately like a sphere having a plurality of grooves.

11. The device of claim 9, wherein the outer body is at least partially formed of translucent thermoplastic rubber.

12. The device of claim 9, further comprising an overmolded external section interconnected an outer surface of the screw section.

13. The device of claim 9, wherein the lighting device comprises at least two LEDs disposed on opposite sides of the control board, and wherein the accelerometer is configured place the LEDs in a first active state when a qualifying impulse is detected, then transition to a flashing state if no further qualifying impulse is detected and then enter a sleep mode.

14. The device of claim 9, wherein the controller is configured, upon detecting a low battery condition of the rechargeable battery, to command a fast blinking pattern of the lighting device.

15. The device of claim 9, wherein control board comprises a primary control board and a secondary control board, the secondary control board carrying the rechargeable battery and the charge port.

16. The device of claim 9, further comprising a module cap coupled to the plug and defining only a single penetration through which the charge port extends.
